(19) United States
(12) Patent Application Publication
(10) Pub. No.: US 2025/0377021 A1
(43) Pub. Date: Dec. 11, 2025

(54) RADIAL ACTUATOR FOR A MAGNETIC RADIAL BEARING MODULE

(71) Applicant: SKF Magnetic Mechatronics, Saint-Marcel (FR)

(72) Inventors: Eduardo CARRASCO, Saint Etienne sous Bailleul (FR); Julien VAUBY, Rouen (FR); Nicolas POLO, Taverny (FR); Eddy HERISSE, les Andelys (FR)

(21) Appl. No.: 19/226,927

(22) Filed: Jun. 3, 2025

(30) Foreign Application Priority Data
Jun. 10, 2024 (FR) 2406073

(51) Int. Cl. F16C 32/04

(52) U.S. Cl. CPC F16C 32/048

(57) ABSTRACT

A radial actuator for a magnetic radial bearing module. The radial actuator 1 comprises an arrangement of coils 2 that are disposed around a central axis XX′. Each coil is formed by a laminated core 3 and by a winding wire 12 electrically insulated from said laminated core 3. The radial actuator 1 includes two separate opposite flanges 5. The flanges are made of an electrically insulating material. The flanges are disposed on either side of the laminated core 3 of at least one of said coils 2. The winding wire 12 of said coil 2 is wound around the two flanges 5 and coming into contact with said flanges.

### CROSS-REFERENCE TO RELATED APPLICATION

This application claims priority to French Application No. FR2406073, filed Jun. 10, 2024, the entirety of which is hereby incorporated by reference.

### FIELD

The present disclosure relates to magnetic actuator modules, in particular for a magnetic radial bearing, and relates in particular to solutions for creating different configurations of radial actuator modules, either in terms of diameter or in terms of length of the active face.

The present disclosure aims to provide a modular radial actuator module, each coil quadrant of which can be produced independently of the others, and which can be adapted to several coil geometries: the number of horns, the height and insulation of the laminated core of the coils, the cross section of the wires and cables used, the type of interconnection, etc.

### BACKGROUND

A magnetic actuator module of a system, such as an industrial machine, conventionally comprises a position sensor and one or more magnetic actuators.

Two methods are known for manufacturing and mounting the coils on the laminated core in order to form a radial actuator integrated into a magnetic bearing module: upstream winding of the coils, on a tool, followed by the mounting thereof with the laminated core being insulated with the aid of an insulating material; or winding the coils onto specific carcasses with a horn size followed by mounting the assembly on the laminated core.

The method with upstream winding of the coil has the drawback of requiring a tool specific to a laminated core size, this necessitating standardization of the laminated core dimensions or expensive multiplication of tools.

Moreover, complementary insulation and mounting are particularly time-consuming operations.

The method with winding of the coil also has the drawback of standardization of the dimensions since the carcass is specific to a laminated core size.

In both cases, the shape of the laminated core is restricted by these manufacturing operations, these limits being in particular in terms of its bulk for ensuring the fitting of the windings of the coil wires on the laminated core.

### SUMMARY

The aim of the present disclosure is to overcome at least some of the abovementioned drawbacks.

In light of the foregoing, the subject of the present disclosure is a radial actuator for a magnetic radial bearing module, having an arrangement of coils that are disposed around a central axis and are each formed by a laminated core and by the winding wire electrically insulated from said laminated core, the radial actuator also comprising two separate opposite flanges which comprise an electrically insulating material and which are disposed on either side of the laminated cores of at least one of said coils, the winding wire of said coil being wound around the two flanges and coming into contact with said flanges.

With this design of the flanges, it is possible to easily change the height of the laminated core of the associated coil to the desired dimension. Moreover, the operations of winding the wire can be carried out easily directly on the flanges.

Preferably, the two flanges are open radially towards the central axis of the position sensor and the laminated cores protrude towards said central axis with respect to the flanges.

This makes it possible to change the length of the laminated core as required, depending on the load capacity requirement of the associated magnetic bearing module.

For example, the flanges axially surround the laminated core of said coil. Alternatively, the flanges may surround the laminated core of said coil in the circumferential direction.

According to a first embodiment, the two flanges are spaced apart axially from one another, the radial actuator also having two insulating elements comprising an electrically insulating material, which are interposed axially between the flanges, that is to say parallel to the central axis, and disposed circumferentially on either side of the laminated core of said coil.

Each insulating element may consist of an electrically insulating paper, an electrically insulating resin, and/or an agglomerated sprayed powder in the gap.

According to a second embodiment, the flanges bear axially against one another.

The flanges may then also each have a notch next to the laminated core of said coil in order to locally increase the circumferential distance between said laminated core and the winding wire.

Advantageously, at least one of said coils has a trapezoidal or pyramid shape.

The radial actuator may also provide that the arrangement of coils forms quadrants of two or more coils, and two flanges are disposed on either side of each of the coils of a single quadrant.

The present disclosure also relates to a magnetic bearing module comprising a magnetic bearing as described above.

### BRIEF DESCRIPTION OF THE DRAWINGS

The present disclosure will be understood better from the detailed examination of several embodiments which are given by way of non-limiting example and illustrated in the appended drawings, in which:

FIG. 1 shows a partial perspective view of a modular radial actuator according to a first embodiment of the present disclosure, having quadrants comprising two coils with independent coils wound on flanges with a single horn.

FIG. 2 shows a partial perspective view of a modular radial actuator according to a second embodiment of the present disclosure, having quadrants comprising two coils with a single flange having two horns.

FIG. 3 shows another perspective view of a modular radial actuator according to a third embodiment of the present disclosure with the inside diameter of the laminated core having been changed.

FIG. 4 shows another perspective view of a modular radial actuator according to a fourth embodiment of the present disclosure with the height of the laminated core having been changed.

FIG. 5 shows another perspective view of a modular radial actuator according to a fifth embodiment of the present disclosure with the inside diameter and the height of the laminated core having been changed.

FIG. 6 shows a view in cross section at a coil of the modular radial bearing in FIG. 3.

FIG. 7 shows another view in cross section at a coil of the modular radial bearing in FIG. 4.

FIG. 8 show a view in cross section of FIG. 5.

### DETAILED DESCRIPTION

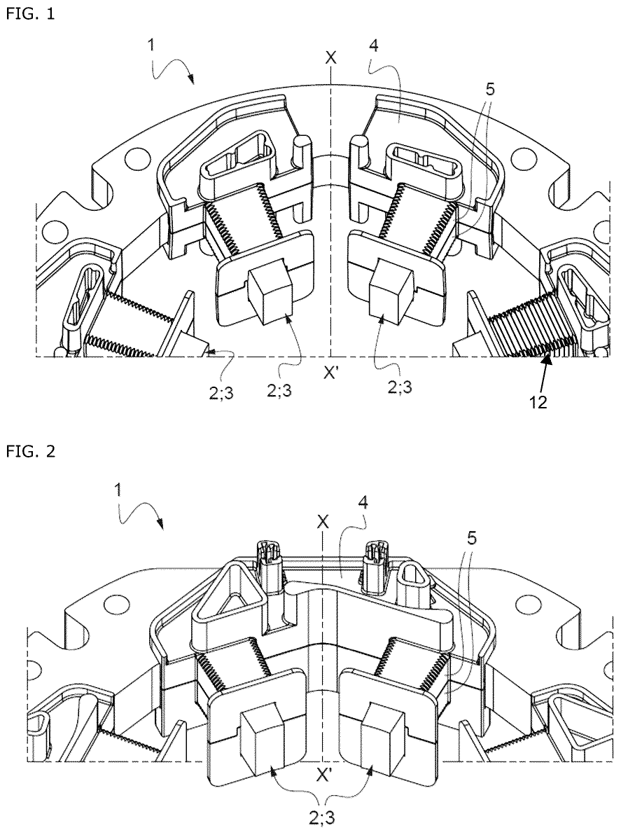

FIG. 1 illustrates the radial actuator for a magnetic radial bearing module 1 according to a first embodiment of the present disclosure.

The radial actuator 1 has an arrangement of coils 2 that are disposed around a central axis XX′ and are each formed by one or more laminated cores 3 and by the winding wire 12 (shown around one of the coils in FIG. 1), which is electrically insulated from said one or more laminated cores 3.

The arrangement of coils 2 forms a concentric ring of coils 2 around the central axis XX′, which are intended to accommodate a mechanical shaft at the centre thereof along said central axis XX′, for a rotating, in particular industrial, machine.

The radial actuator 1 also comprises, for each coil 2, two separate opposite flanges 5, which are disposed on either side of the laminated core 3 of said coil 2, the winding wire 12 surrounding the two flanges 5.

The flanges 5 comprise an electrically insulating material.

The flanges 5 are intended to receive, on their outer surface, winding wire 12, made in particular of copper, surrounding the two opposite flanges 5 so as to form a coil 2. The winding wire 12 is wound around the two flanges 5 and comes into contact with said flanges. The winding wire 12 is not wound directly around the laminated core 3.

In the exemplary embodiment illustrated, the flanges 5 are identical to one another and have a U-shaped cross section.

The flanges 5 are symmetric with respect to a median radial plane of the coil.

In the exemplary embodiment illustrated, the flanges 5 bear axially against one another and delimit a channel inside which the laminated core 3 of the associated core extends.

In the exemplary embodiment illustrated, the two flanges 5 are open radially towards the inside, i.e. towards the central axis XX′, and the laminated cores 3 protrude towards the central axis XX′ with respect to the flanges 2.

For example, the flanges 5 axially surround the laminated core 3 of the associated coil.

The open shape of the flanges 5 does not cover the entire radial length of the horns of the laminated core 3 of the associated coil, thereby making it possible to change the length of the horn formed by the laminated core 3 as required, and this will make it possible reduce the number of individual carcasses of coils 2 and to change the inside diameter of the radial actuator 1.

It is also possible to change the height of the laminated core 3 of the associated coil given that the flanges 5 are produced in the form of two separate parts.

In FIG. 1, the radial actuator 1 is such that each coil 2 belongs to a single quadrant, that is to say one having one coil 2.

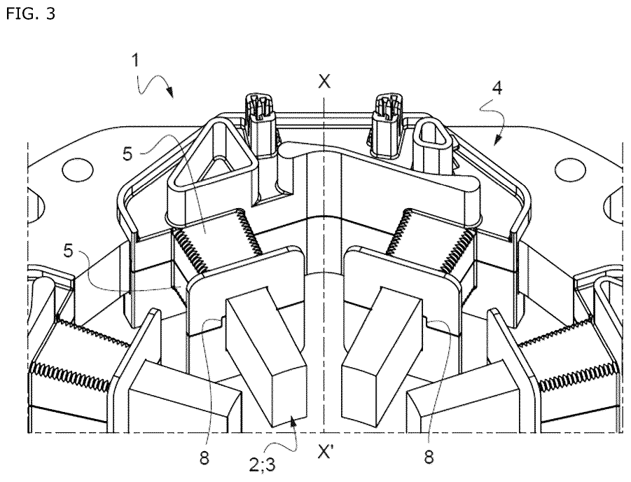

In the second embodiment illustrated in FIG. 2, the radial actuator 1 may alternatively be such that the arrangement of coils 2 forms quadrants 4 of several coils 2, for example two or more coils 2, for example three coils 2, in this instance two coils 2 in FIG. 2, and such that the two flanges 5 are disposed on either side of all the coils 2 of the same quadrant 4.

This makes it possible to share the flanges 5, and to further increase the modularity of the design of the radial actuator 1.

In this design, each flange 5 is suited to the shape of several successive laminated cores 3, and connects all the coils 2 of a single quadrant 4.

The two opposite flanges 5 are always disposed on each side of the corresponding laminated core 3 of the quadrant 4 and make it possible to insulate the laminated cores 3 from the winding wires 12 during the automatic winding thereof in situ.

The benefit of shaping into a quadrant 4 is that of not being dependent on the overall expansion of the radial actuator 1 and of creating a part made of electrically insulating material, for example plastic, which is smaller and therefore more economical to manufacture.

The existence of two opposite flanges 5 rather than just one covering the entire laminated core also allows the thermal expansion stresses to be reduced in the two flanges 5 since they do not propagate from and to the two flanges 5.

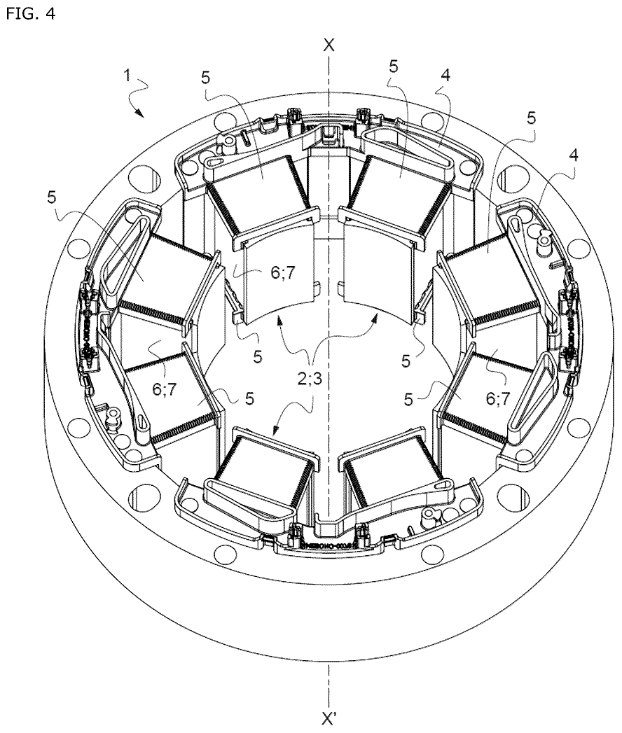

FIG. 3 illustrates a third embodiment in which the laminated cores 3 may be designed with a longer shape towards the centre of the radial actuator 1 for a given single pair of flanges 5 inasmuch as the flanges are radially open towards the inside. It is thus possible to change the length of the horn of the laminated core 3 and the diameter of the active zone, in particular depending on the load capacity requirement of the magnetic bearing module.

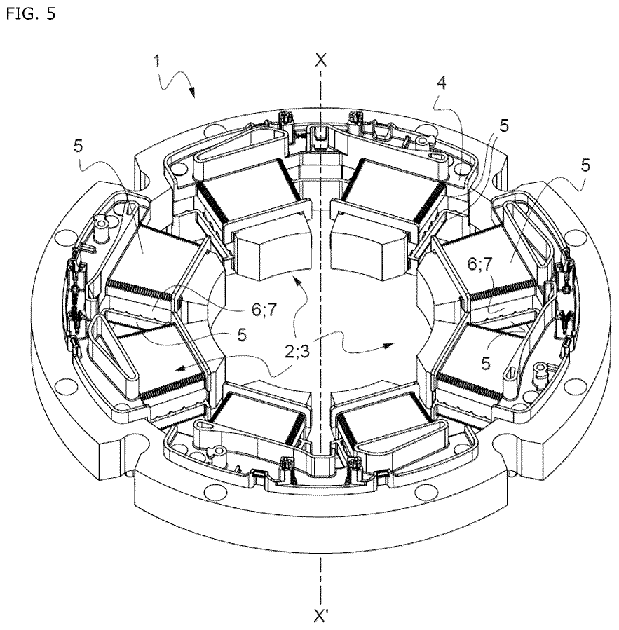

FIG. 4 illustrates a fourth embodiment in which the laminated cores 3 of each coil have a greater height, this being possible for a single form of flanges 5 since they are formed by two separate parts, meaning that they can be separated and positioned independently of one another.

Thus, as illustrated in FIGS. 1, 2 and 3, the two flanges 5 can be joined and pressed against one another, avoiding the need for a gap separating the flanges 5, and therefore the need to add electrical insulation between the winding wire 12 in the contact zone of the two flanges 5.

In the first, second and third embodiments, the two flanges 5 covering the laminated core 3 are, for example, interlocked in order to effect this covering and to ensure continuity of insulation.

This solution involves a set or different parts depending on the height of the laminated core 3.

Alternatively, in the first, second and third embodiments, when the two flanges 5 are mounted without bearing against one another or sealed tightly, the flanges 5 are separated by ambient gas, for example air, which is a relatively weak electrical insulator.

When ambient air is used between the two flanges 5, the continuity of electrical insulation between the winding wires 12 covering the flanges 5 and the laminated cores 3 can be ensured by virtue of a design in which the flanges 5 each have a notch 8, visible in FIGS. 3, 6 and 7, which is suitable for sufficiently increasing the distance between the laminated core 3 and its winding wire 12, in particular the air gap.

Specifically, industrial machine standards set electrical insulation distances between the wound elements and the metal faces, in this instance the lamination of the laminated cores 3.

With a conventional one-piece flange, that is to say one extending circumferentially all around the laminated core 3, the continuity of insulation is ensured continuously all around the laminated core 3.

Conversely, in the case of a part that is open or separated into two flanges 5, the continuity of electrical insulation can be ensured by a foreign insulating body or by complying with a set air gap.

This solution prevents the covering of the electrically exposed surfaces of the laminated core 3, and the addition of external components such as insulating elements 7, by creating air insulation by moving the outer surfaces of the flanges 5 supporting the passage of the winding wire 12 sufficiently far away from the metal surfaces of the laminated core 3 in order to comply with the distances according to the standards used.

For example, it is recommended to create a notch 8 such that the air gap between the laminated core 3 and its winding wire 12 is at least two and a half millimetres, in order to ensure electrical insulation by virtue of said ambient gas.

Thus, provision may be made for the ambient air to comprise air and for the distance between the laminated core 3 and its winding wire 12 to be greater than or substantially equal to two and half millimetres, in order to ensure sufficient electrical insulation for the operation of the radial actuator 1.

In the fourth and fifth embodiments illustrated in FIGS. 4 5 and 7, the two flanges 5 are spaced apart axially from one another, the radial actuator 1 also having two insulating elements 7 comprising an electrically insulating material that are interposed axially between the flanges 5 and disposed circumferentially on either side of the laminated core 3 of said coil 2.

Since the two flanges 5 are separate, there is a gap 6 between said flanges 5, which may include said insulating elements 7, as illustrated in FIGS. 4 5 and 7. The winding wire 12 is wound around the two flanges 5 and the insulating elements 7, and comes into contact with said flanges and said insulating elements. The winding wire 12 is not wound directly around the laminated cores 3.

The insulating elements 7 are chosen to have a particularly high dielectric coefficient.

Advantageously, the insulating elements 7 consist of an electrically insulating paper 9, an electrically insulating resin, and/or an agglomerated sprayed powder in the gap 6.

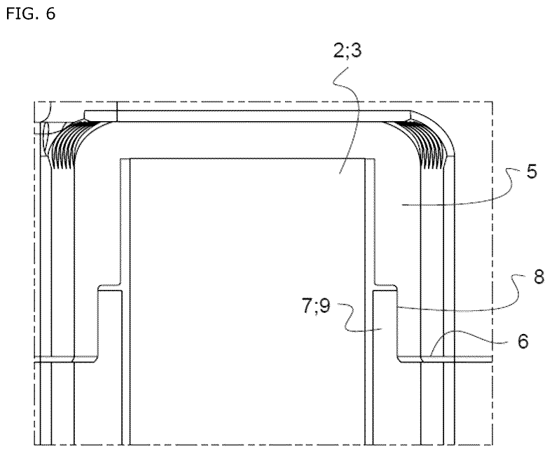

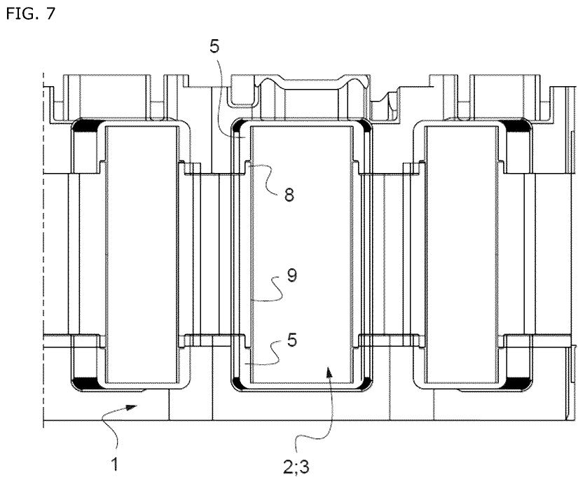

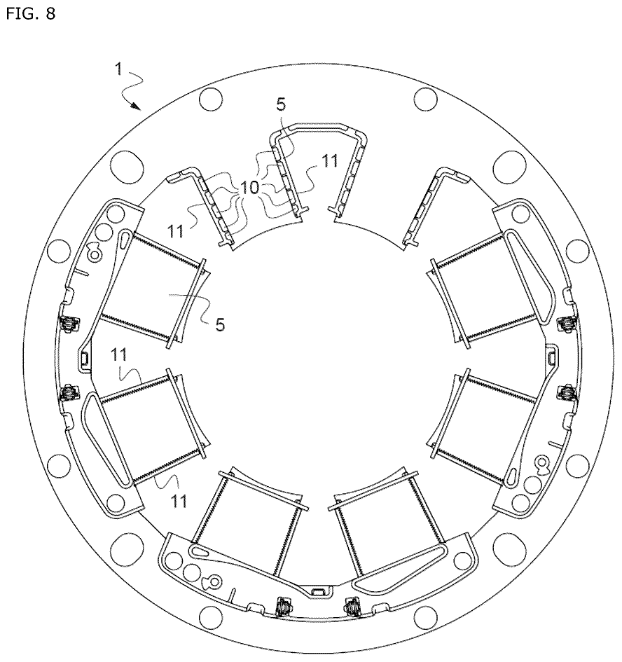

As shown in detail in FIGS. 6 and 7, which illustrate the fifth embodiment, the notch 8 of the first, second and third embodiments may also be used in the fourth and fifth embodiments since it can serve as a slot for keeping the insulating elements 9 in position, in particular when these consist of an electrically insulating paper in the form of a strip.

By virtue of such a slot function of the notch 8, there is no need to mechanically constrain the insulating elements 7 in order for them to maintain their shape throughout the lifetime of the radial actuator 1, since the insulating elements 7 are inserted on either side into the notch 8 of each flange 5, and can move freely towards one another between the two, thereby allowing a more lightweight design compared with a design with added retaining means which entail a hold that is too constrained and/or hyperstatic.

The recess comprising a notch 8 therefore makes it possible to afford greater durability of the insulating elements 7 and of the radial actuator 1.

In addition, this low constraint design of the insulating elements 7 makes it easier to fit them on either side of one of the laminated cores 3, since all that is necessary is to insert them into the notches 8, thereby making it easier to manufacture the radial actuator 1.

The addition of insulating elements 7, in particular thin ones, combined with covering of the flanges 5 to ensure the insulating distance, is a solution suitable for all heights of laminated cores 3, even if the implementation thereof requires a specific insulator length for each version of laminated core 3.

As illustrated in FIG. 8, the fifth embodiment may also provide spaces 10 formed by a spacer 11 added to a flange 5 or formed thereby, making it possible to space this flange 5 apart from the laminated core 3, in order to ensure that the winding wires 12 are disposed at a distance allowing electrical insulation by the ambient gas, in particular the air around said laminated core 3.

The spacer 11 thus has a toothed shape to allow a spacing including a maximum amount of air.

One of the most economical alternatives is to replace the addition of thin insulating elements 9 with prior protection of the laminated core 3 at the relevant faces of the laminated core 3, namely those that are electrically exposed, by virtue of depositing a resin in the form of a thermally agglomerated powder.

Advantageously, in any embodiment, at least one coil 2 has a trapezoidal or pyramid shape.

These shapes, which are formed by laminated cores 3 in the form of slabs having non-parallel faces directed towards the centre of the radial actuator 1, are made possible by virtue of the manufacturing method incorporating the two separate flanges 5 around the laminated cores 3.

The substantially pyramid or trapezoidal shape optimizes the essential filling of a coil 2, this being impossible in the usual manufacturing techniques on account of the mechanical interference between the coils 2 while they are being inserted.

The present disclosure also relates to a magnetic bearing module comprising a magnetic bearing and a radial actuator 1 as described above, in which the coils 2 have winding wire 12 wound around the flanges 5.

The present disclosure also relates to a method for manufacturing such a magnetic bearing module, in which the two flanges 5 are disposed on either side of one of the laminated cores 3, followed by the addition of an electrically insulating resin and/or an agglomerated sprayed powder in the gap 6, and then so-called needle winding is carried out, allowing the winding wire 12 to be wound around the two flanges 5 and said resin and/or powder so as to form a coil 2 in which said winding wire is both wound around the two flanges 5 and electrically insulated from any laminated core 3 by said flanges 5 and by said electrically insulating resin, and/or agglomerated sprayed powder.

What is claimed is:

1. A radial actuator for a magnetic radial bearing module, the radial actuator comprising:
an arrangement of coils disposed around a central axis, each coil including a laminated core and a winding wire electrically insulated from said laminated core
two separate opposite flanges comprising an electrically insulating material, the two flanges being disposed on either side of the laminated core of at least one of said coils, the winding wire of said one coil being wound around the two flanges and coming into contact with said two flanges.

2. The radial actuator according to claim 1, wherein the two flanges are open radially towards the central axis and the laminated core protrudes towards said central axis with respect to the flanges.

3. The radial actuator according to claim 1, wherein the two flanges axially surround the laminated core of said one coil.

4. The radial actuator according to claim 1, wherein the two flanges are spaced apart axially from one another, wherein the radial actuator further comprises two insulating elements comprising an electrically insulating material, the two insulating elements being interposed axially between the two flanges and disposed circumferentially on either side of the laminated core of said one coil.

5. The radial actuator according to claim 4, wherein the insulating elements consist of an electrically insulating paper, an electrically insulating resin, and/or an agglomerated sprayed powder in the gap.

6. The radial actuator according to claim 1, wherein the two flanges bear axially against one another.

7. The radial actuator according to claim 6, wherein the two flanges each have a notch next to the laminated core of said one coil in order to locally increase the circumferential distance between said laminated core and the winding wire.

8. The radial actuator according to claim 1, wherein at least one of said coils has a trapezoidal or pyramid shape.

9. The radial actuator according to claim 1, wherein the arrangement of coils forms quadrants of two or more coils, and two flanges are disposed on either side of each of the coils of a single quadrant.

10. The radial actuator according to claim 2, wherein the two flanges axially surround the laminated core of said one coil.

11. The radial actuator according to claim 10, wherein the two flanges are spaced apart axially from one another, wherein the radial actuator further comprises two insulating elements comprising an electrically insulating material, the two insulating elements being interposed axially between the two flanges and disposed circumferentially on either side of the laminated core of said one coil.

12. The radial actuator according to claim 11, wherein the insulating elements consist of an electrically insulating paper, an electrically insulating resin, and/or an agglomerated sprayed powder in the gap.

13. The radial actuator according to claim 10, wherein the two flanges bear axially against one another.

14. The radial actuator according to claim 13, wherein the two flanges each have a notch next to the laminated core of said one coil in order to locally increase the circumferential distance between said laminated core and the winding wire.

15. The radial actuator according to claim 14, wherein at least one of said coils has a trapezoidal or pyramid shape.

16. The radial actuator according to claim 15, wherein the arrangement of coils forms quadrants of two or more coils, and two flanges are disposed on either side of each of the coils of a single quadrant.

17. A magnetic bearing module comprising a magnetic bearing and a radial actuator according to claim 16.

18. A magnetic bearing module comprising a magnetic bearing and a radial actuator according to claim 1.
